(19) United States
(12) Patent Application Publication
(10) Pub. No.: US 2007/0257881 A1
(43) Pub. Date: Nov. 8, 2007

(54) Music player and method

(76) Inventors: Marja-Leena Nurmela, Routio (FI); Heini Tuorila, Oulu (FI); Dominick Reed, Brinkley (GB)

Correspondence Address: PERMAN & GREEN, 425 POST ROAD, FAIRFIELD, CT, 06824, US

(21) Appl. No.: 11/430,263

(22) Filed: May 8, 2006

(51) Int. Cl. G09G 5/00

(52) U.S. Cl. 345/156

(57) ABSTRACT

A method for providing a user interface of a portable music player. The method uses a tap sensitive sensor and a memory, the method includes detecting a tap and a direction of the tap, and finding an action corresponding to the tap using a tap-action table stored in the memory, wherein the table associates a detected tap comprising a direction of the tap with an action. Corresponding portable music players and computer program product are also presented.

### FIELD OF THE INVENTION

The aspects of the invention generally relate to portable music players and more particularly to user input of portable mobile terminals.

### BACKGROUND OF THE INVENTION

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, exercise analysis, electronic games, calendar/organizer/time planner, word processing, etc. Furthermore, the modern terminals have local connectivity abilities, such as Bluetooth, allowing the mobile terminals to communicate with a wide array of devices.

Being mobile, the mobile terminals are naturally often used while the user is moving. When in movement, it requires close attention by the user to provide user input to the mobile terminal.

In the prior art, one attempt to simplify user interaction while in movement is to allow the user to control the mobile terminal with voice control. In this way, the user can speak commands into a microphone of the mobile terminal to control the mobile terminal. While this solution somewhat alleviates user interaction while mobile, it can be awkward to speak commands into a mobile phone, e.g. when using public transport. Additionally, it can sometimes be difficult for the mobile terminal to distinguish between the allowable commands, particularly if several users share usage of one terminal.

Consequently, there is a need to provide a mobile communication terminal and method providing a user interface which is easier to use while the user is mobile.

### SUMMARY OF THE INVENTION

In view of the above, an objective of the invention is to solve or at least reduce the problems discussed above.

Generally, the above objectives are achieved by the attached independent patent claims.

According to a first aspect of the invention there has been provided a method for providing a user interface of a portable music player comprising a tap sensitive sensor and a memory, the method comprising: detecting a tap and a direction of the tap, and finding an action corresponding to the tap using a tap-action table stored in the memory, wherein the table associates a detected tap comprising a direction of the tap with an action.

The tap data may be differentiated between a double tap and a single tap by measuring a time difference between two subsequent taps in a same direction detected by the tap sensor and deciding whether this time difference is above or below a time threshold.

The actions stored in the tap-action table may comprise the actions play, pause, next track and previous track, and the actions may be related to a media player application.

The action of play may be associated with a direction being, within a margin of error from, a direction directed perpendicularly towards a display of the portable music player.

The action of pause may be associated with a direction being, within a margin of error from, a direction directed perpendicularly towards a display of the portable music player.

The action of next track may be associated with a direction being, within a margin of error from, a direction directed perpendicularly towards a first side surface of the portable music player.

The action of previous track may be associated with a direction being, within a margin of error from, a direction directed perpendicularly towards a second side surface of the portable music player.

The actions stored in the tap-action table may comprise at least a subset of the actions mute, unmute, next radio station and previous radio station, and the actions may be related to a radio application.

The action of mute may be associated with a direction being, within a margin of error from, a direction directed perpendicularly towards a display of the portable music player.

The action of unmute may associated with a direction being, within a margin of error from, a direction directed perpendicularly towards a display of the portable music player.

The action of next radio station may be associated with a direction being, within a margin of error from, a direction directed perpendicularly towards a first side surface of the portable music player.

The action of previous radio station may be associated with a direction being, within a margin of error from, a direction directed perpendicularly towards a second side surface of the portable music player.

A second aspect of the invention is a portable music player comprising a memory, a controller and a tap sensitive sensor, wherein the tap sensitive sensor is configured to detect a tap and a direction of the tap, and the controller is configured to, upon receiving tap data from the tap sensitive sensor, find a corresponding action using a tap-action table stored in the memory wherein the table associates a detected tap comprising a direction of the tap with an action.

The actions stored in the tap-action table may comprise the actions play, pause, next track and previous track.

The controller may be configured to differentiate between a double tap and a single tap by measuring a time difference between two subsequent taps in a same direction detected by the tap sensor and deciding whether this time difference is above or below a time threshold.

The tap sensitive sensor may comprise a motion sensor.

The tap sensitive sensor may comprise an accelerometer.

A third aspect of the invention is a portable music player configured to provide a user interface, the portable music player comprising: a controller, a tap sensitive sensor, means for detecting a tap and a direction of the tap, and means for finding an action corresponding to the tap using a tap-action table stored in the memory, wherein the table associates a detected tap comprising a direction of the tap with an action

A fourth aspect of the invention is a computer program product comprising software instructions that, when executed in a portable music player, performs the method according to the first aspect.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be described in more detail, reference being made to the enclosed drawings, in which:

FIG. 1 is a schematic illustration of a cellular telecommunication system, as an example of an environment in which the present invention may be applied.

FIG. 2a is a schematic front view illustrating a mobile terminal according to an embodiment of the present invention.

FIG. 2b is a schematic side view illustrating the mobile terminal in FIG. 2a.

FIG. 3 is a schematic block diagram representing an internal component, software and protocol structure of the mobile terminal shown in FIG. 2a and 2b.

FIG. 4 is a schematic diagram showing how operational modes can be switched in an embodiment of the present invention.

FIGS. 5a, 5b and 5c are a front, side and bottom view, respectively, of the mobile terminal of FIG. 2a, shown in a x-y-z co-ordinate system.

### DETAILED DESCRIPTION OF THE INVENTION

The present invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

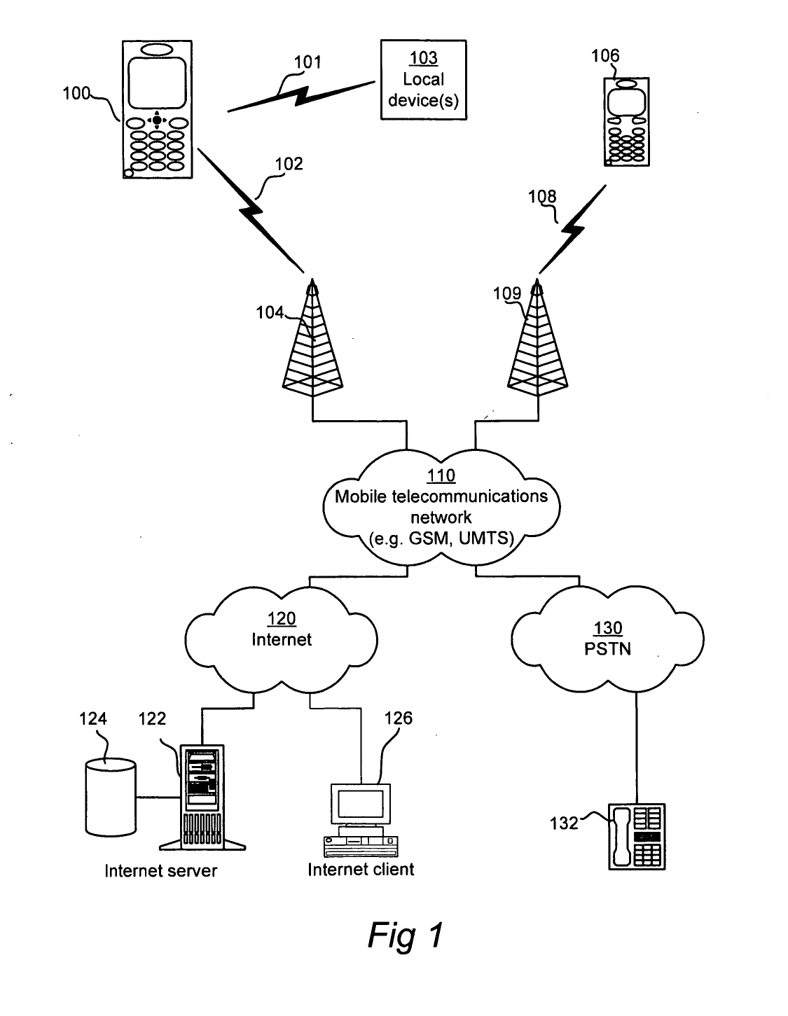

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be various sensors that can communicate measurement values to the mobile terminal 100 over the local link 101.

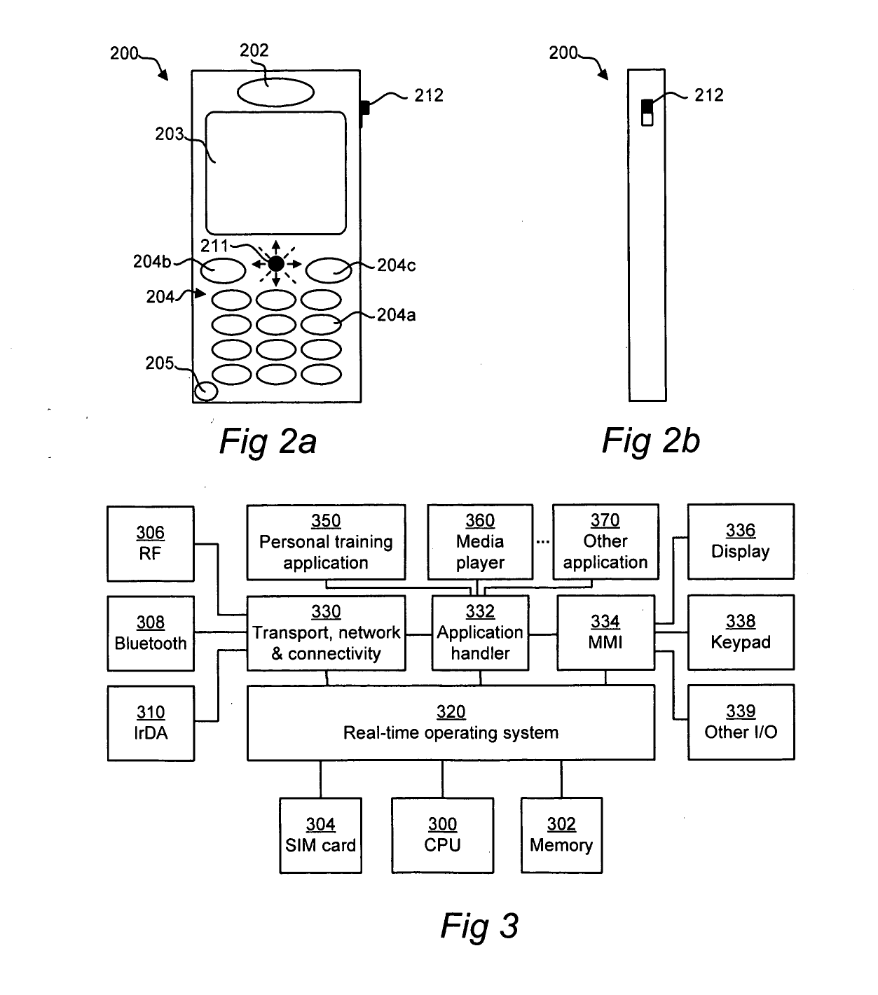

An embodiment 200 of the mobile terminal 100 is illustrated in more detail in FIG. 2a. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device.

A mode switch button 212 is also provided, as can be seen more clearly in FIG. 2b. The button is used to switch an operating mode of the mobile terminal. In this embodiment, the button is by default positioned in an upper position. When the user wants to switch modes, the button is moved to a lower position and released, after which the button returns to the default upper position by mechanical means, such as a spring or similar. As the man skilled in the art will realize, the functionality of the mode switch button could easily be replaced with a push button or any other suitable type of input device.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications can include a personal exercise application 350, a media player application 360, as well as various other applications 370, such as applications for voice calling, video calling, sending and receiving SMS, MMS or email, web browsing, an instant messaging application, a phone book application, a calendar application, a control panel application, a camera application, one or more video games, a notepad application, etc.

The MMI 334 also includes one or more hardware controllers, which together with the MMI drivers cooperate with the display 336/203, keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

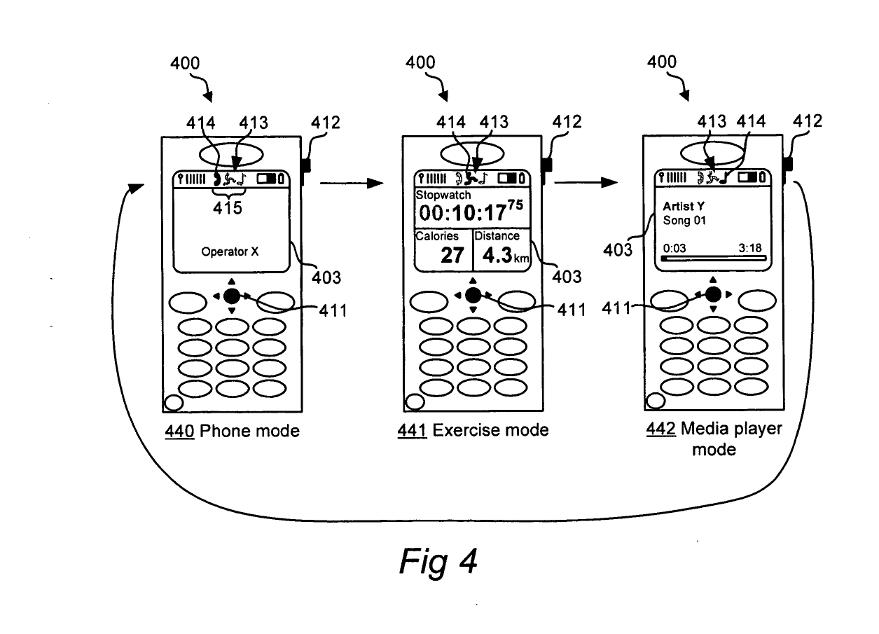

FIG. 4 shows how operational modes can be switched in an embodiment of the present invention. The mobile terminal 400, such as mobile terminal 200 of FIG. 2a, comprises a display 403, such as display 203 of FIG. 2a, a joystick 411, such as joystick 211 of FIG. 2a, and a mode switch button 412 such as mode switch button 212 of FIG. 2a to allow the user to switch operational modes.

Operational modes are modes where the mobile terminal 400 behaves in a specific way. For example, FIG. 4 shows 3 operational modes: a phone mode 440, an exercise mode 441 and a media player mode 442.

When the mobile terminal 400 is in the phone mode 440, the mobile terminal behaves as a user would expect a regular mobile terminal to behave. In other words, a menu system and/or shortcuts allow the user to instruct the mobile terminal to perform a desired function, such as voice telephony, www/wap browsing, video telephony, electronic messaging (e.g. SMS, MMS, email, instant messaging), digital image or video recording, electronic games, calendar/organizer/time planner, word processing, etc.

When the mobile terminal 400 is in the exercise mode 441, the main purpose of the mobile terminal is to provide the user with applications related to the physical exercise of the user.

In one embodiment, an accelerometer is integrated in the mobile terminal 400. In another embodiment, an external accelerometer is connected to the mobile terminal 400, e.g. over a local link, such as the local link 101 in FIG. 1. The accelerometer can detect acceleration and thereby steps that the user takes while the mobile terminal is carried by the user. When an accelerometer is integrated or connected to the mobile terminal 400, the mobile terminal automatically measures movement during the day. If the user previously has entered personal information, such as weight, height, etc., the mobile terminal 400 can convert the data from the accelerometer to other measurements, such as covered distance and burnt calories. Optionally, a GPS (Global Positioning System) sensor can be either integrated in, or connected to, the mobile terminal 400 to allow accurate distance measurement. Also, an external heart beat monitor can be connected to the mobile terminal 400 to detect heart beats and calculate heart rate.

When the mobile terminal 400 is in the media player mode 442, the main purpose of the mobile terminal is to play media to the user. For example, the media player can play music or sound files, such as MP3 (mpeg-1 audio layer 3) files, AAC (advanced audio coding) files or ogg files. Optionally, the media player can also be used to listen to FM (frequency modulated) radio, or to play video files according to standards such as MPEG-2, MPEG-4 or H.323.

As the user switches operational modes with mode switch button 412, the modes are switched serially. In the illustrated embodiment, there is a list of operational modes consisting of the phone mode 440, the exercise mode 441, and the media player mode 442, in that order. Consequently, if the mobile terminal 400 is in the phone mode 440 and the user actuates the mode switch button 412, the phone switches to the exercise mode 441. Similarly, if the mobile terminal 400 is in the exercise mode 441 and the user actuates the mode switch button 412, the phone switches to the media player mode 442. Finally, if the mobile terminal 400 is in the media player mode 443 and the user actuates the mode switch button 412, the phone loops back and switches to the phone mode 440.

To allow the user to easily determine what mode is currently used, elements of the user interface are specific for each mode. There are a multitude of distinguishing user interface elements that can vary to allow the user to see what mode is currently active, e.g., a centrally located light by the joystick 411 can change color, the background on the display 403 can have different colors or appearances, or the entire theme of the user interface with colors and fonts can change. In one embodiment, one icon 414 of a set of icons 415 at the top of the display 403 is highlighted to indicate which mode is active.

Mode changes can also change sound effects. For example in phone mode 440, the sounds may be discrete or even absent for actions such as button press, enter menu, exit menu, while in exercise mode 441, distinct and loud sounds are played for these actions to give clear feedback to the user while exercising. The media player mode 441 may have a totally different, more cool or ambient sound scheme on the actions mentioned in order to give feedback to the user on actions performed, while still not excessively disturbing the experience of listening to music. Optionally, the sound scheme can furthermore vary depending on whether headphones are connected to the mobile terminal 400 or not. The changes of sounds does not need to be totally different sounds; the changes could be effects applied to sounds. For example, a sound for a button press in phone mode could be reused in the media player mode, with a strong reverberation effect on it to give a more ambient effect while still providing familiarity to the user.

Additionally, a temporary user indication can be given when the actual mode change occurs. For example, the vibrator may vibrate on a mode change, where the vibration is either always identical for all modes or every mode has a particular vibration associated with it. Additionally, a dialog can show the name of the new operational mode in the display 403, or a sound effect or speech synthesizer pronouncing the new mode can be played to the user.

It is to be noted that although the modes can be switched certain appropriate processing of an inactive mode can still be performed. For example, the exercise application can count the steps of the user in the background, regardless of what mode the mobile terminal is in. Similarly, the media player can let the user hear an FM radio station while the mobile terminal is in exercise mode, or the phone application can temporarily interrupt current processing if there an incoming phone call is detected.

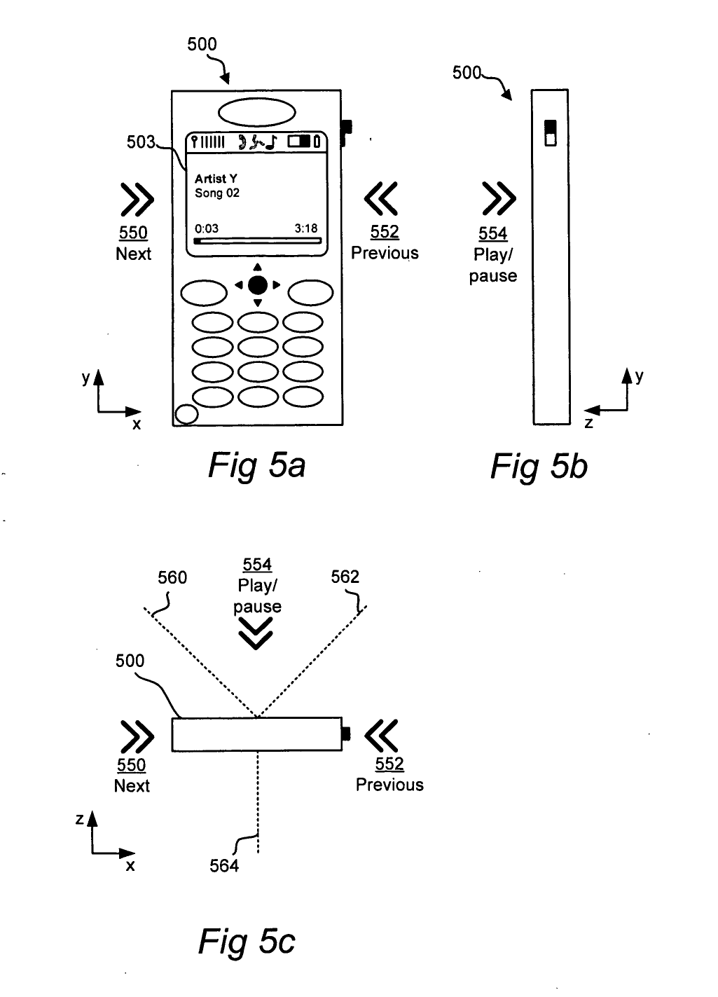

FIGS. 5a, 5b and 5c are a front, side and bottom view, respectively, of the mobile terminal of FIG. 2a, shown in a x-y-z co-ordinate system. It is here shown how tapping can be used to control certain aspects of the mobile terminal.

In FIG. 5a, the media player 360 of the mobile terminal 500 is currently playing a song, as can be seen on the display 503. If the user wants to skip to the next song, the user simply double-taps with his/her fingers, hand or pointing tool (e.g. pen or stylus) on the left side of the mobile terminal 500, to invoke a next action 550. The double-tap requires that a motion sensor, such as an accelerometer, is integrated or attached to the mobile terminal 500. The motion sensor can be the accelerometer described above in conjunction with FIG. 4. The motion sensor generates a signal when the mobile terminal 500 is tapped which is analyzed by the controller in the mobile terminal 500, such as controller 300 of FIG. 3, to distinguish a tap on the left side of the mobile terminal 500. If two taps on the left side are detected within a certain period of time, the taps are considered a double-tap on the left, and the controller instructs the media player application to skip to the next track.

Similarly, if a double-tap is detected on the right side of the mobile terminal 500, a previous action 552 is determined and the controller instructs the media player to skip to a previous track. If a double-tap is detected on the front face of the mobile terminal, a play/pause action 554 is determined. This action is state dependent, such that if the player is currently not playing a track, i.e. the player is in a paused or stopped state, the controller instructs the media player to start playing. On the other hand, if the player is playing a track when the play/pause action 554 is determined, the controller instructs the media player to pause playing.

FIG. 5c is a bottom view of the mobile terminal 500 illustrating directions of the double-tap controls. Here it can be seen that the left double-tap is essentially perpendicular to the front double-tap, which in turn is essentially perpendicular to the right double-tap. While it is by no means necessary that these directions are perpendicular to each other, it is beneficial as a relatively large margin of error can be utilized for each direction.

The indicative line 560 shows a border between a left region where the tap is determined to be a left tap and a top region where the tap is determined to be a front tap. Similarly, the indicative line 562 shows a border between a top region where the tap is determined to be a top tap and a right region where the tap is determined to be a right tap. Also, the indicative line 564 shows a border between a left region where the tap is determined to be a left tap and a right region where the tap is determined to be a right tap. As can be seen, this results in rather large left, right, and top regions, respectively, allowing that the user is not perfectly accurate when the user taps the mobile terminal 500 to control the media player.

It is to be noted that even though three different directions are shown here to control three different controls of the media player, any number of distinguishable directions can be used. Specifically, double-taps in a y-direction can be utilized to serve as an input.

If the mobile phone 500 currently executes a FM radio, a next action 550 can trigger the radio to go to the next radio station. The next radio station can be determined as either a next radio station in a list of preset radio stations or it can be determined as a next available radio station with acceptable reception quality in the radio spectrum. Similarly, a previous action 552 triggers the radio to go the previous radio station. A play/pause action 554 can trigger that the radio toggles between an unmuted and a muted mode. It is to be noted that the radio application can be a separate radio application or it can be a specific mode of the previously mentioned media player application.

While it is here presented that double-tapping controls the various actions described above, single tapping can equally well be utilized. If single tapping is used, extra consideration needs to be taken to be able to distinguish between a deliberate single tap and regular movement of the mobile terminal 500 due to the terminal being moved while being carried by a person.

Although the invention has above been described using an embodiment in a mobile terminal, the invention is applicable to any type of music player, including portable mp3-players, etc.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for providing a user interface of a portable music player comprising a tap sensitive sensor and a memory, said method comprising:
detecting a tap and a direction of said tap, and
finding an action corresponding to said tap using a tap-action table stored in said memory, wherein said table associates a detected tap comprising a direction of said tap with an action.

2. The method according to claim 1, wherein said tap data is differentiated between a double tap and a single tap by measuring a time difference between two subsequent taps in a same direction detected by the tap sensor and deciding whether this time difference is above or below a time threshold.

3. The method according to claim 1, wherein said actions stored in said tap-action table comprise the actions play, pause, next track and previous track, and said actions are related to a media player application.

4. The method according to claim 3, wherein said action of play is associated with a direction being, within a margin of error from, a direction directed perpendicularly towards a display of said portable music player.

5. The method according to claim 3, wherein said action of pause is associated with a direction being, within a margin of error from, a direction directed perpendicularly towards a display of said portable music player.

6. The method according to claim 3, wherein said action of next track is associated with a direction being, within a margin of error from, a direction directed perpendicularly towards a first side surface of said portable music player.

7. The method according to claim 3, wherein said action of previous track is associated with a direction being, within a margin of error from, a direction directed perpendicularly towards a second side surface of said portable music player.

8. The method according to claim 1, wherein said actions stored in said tap-action table comprise at least a subset of the actions mute, unmute, next radio station and previous radio station, and said actions are related to a radio application.

9. The method according to claim 8, wherein said action of mute is associated with a direction being, within a margin of error from, a direction directed perpendicularly towards a display of said portable music player.

10. The method according to claim 8, wherein said action of unmute is associated with a direction being, within a margin of error from, a direction directed perpendicularly towards a display of said portable music player.

11. The method according to claim 8, wherein said action of next radio station is associated with a direction being, within a margin of error from, a direction directed perpendicularly towards a first side surface of said portable music player.

12. The method according to claim 8, wherein said action of previous radio station is associated with a direction being, within a margin of error from, a direction directed perpendicularly towards a second side surface of said portable music player.

13. A portable music player comprising a memory, a controller and a tap sensitive sensor, wherein
said tap sensitive sensor is configured to detect a tap and a direction of said tap, and
said controller is configured to, upon receiving tap data from said tap sensitive sensor, find a corresponding action using a tap-action table stored in said memory wherein said table associates a detected tap comprising a direction of said tap with an action.

14. The portable music player according to claim 13, wherein said actions stored in said tap-action table comprise the actions play, pause, next track and previous track.

15. The portable music player according to claim 13, wherein said controller is configured to differentiate between a double tap and a single tap by measuring a time difference between two subsequent taps in a same direction detected by the tap sensor and deciding whether this time difference is above or below a time threshold.

16. The portable music player according to claim 13, wherein said tap sensitive sensor comprises a motion sensor.

17. The portable music player according to claim 13, wherein said tap sensitive sensor comprises an accelerometer.

18. A portable music player configured to provide a user interface, said portable music player comprising:
a controller,
a tap sensitive sensor,
means for detecting a tap and a direction of said tap, and
means for finding an action corresponding to said tap using a tap-action table stored in said memory, wherein said table associates a detected tap comprising a direction of said tap with an action

19. A computer program product comprising software instructions that, when executed in a portable music player, performs the method according to claim 1.
